(19) United States
(12) Patent Application Publication
(10) Pub. No.: US 2011/0114095 A1
(43) Pub. Date: May 19, 2011

(54) ANTIVIRAL METAL IMPREGNATED ACTIVATED CARBON CLOTH COMPONENTS

(75) Inventors: Andrea SMITH, Tyne and Wear (GB); Jack TAYLOR, Cramlington (GB)

(73) Assignee: CALGON CARBON CORPORATION, Pittsburgh, PA (US)

(21) Appl. No.: 12/948,381

(22) Filed: Nov. 17, 2010

Related U.S. Application Data
(60) Provisional application No. 61/261,861, filed on Nov. 17, 2009.

(51) Int. Cl. A62B 7/10; A01N 25/08; A01N 59/16; A01N 59/20; A01P 1/00

(52) U.S. Cl. 128/206.19; 424/400; 424/618; 424/630

(57) ABSTRACT

An adaptable component having antiviral and virucidal properties is disclosed. The component generally comprises of a metal impregnated activated carbon cloth, an inner layer positioned along one side of the cloth and an outer layer positioned along the opposite side of the cloth. The layers can be attached together along all or a portion of a perimeter. The component can also have a protective membrane positioned between the outer layer and the activated carbon cloth. The components can be of benefit used in facemask composite, medical clothing such as gowns and scrubs, bed linen and protective clothing for military purposes.

### CROSS-REFERENCE TO RELATED APPLICATIONS

This application claims benefit of priority to U.S. Provisional Patent Application No. 61/261,861 filed on Nov. 17, 2009 entitled “Antiviral Metal Impregnated Activated Carbon Cloth Components,” the entire contents of which are hereby incorporated by reference.

### GOVERNMENT INTERESTS

Not applicable

### PARTIES TO A JOINT RESEARCH AGREEMENT

Not applicable

### INCORPORATION BY REFERENCE OF MATERIAL SUBMITTED ON A COMPACT DISC

Not applicable

### BACKGROUND

1. Field of the Invention

Embodiments of the present invention generally relate to activated carbon cloth having antiviral and virucidal properties and components incorporating such cloth.

2. Background of the Invention

The following background information is provided to assist the reader to understand embodiments of the invention disclosed below and the context in which they may be used. The terms used herein are not intended to be limited to any particular narrow interpretation unless clearly stated otherwise, either expressly or impliedly, in this document.

Over the past decade the threat of a serious global viral pandemic has grown significantly. The need to prevent or otherwise minimize the effects of such a viral pandemic has correspondingly increased. Viruses are highly contagious. Prevention of the transmissions of viruses is difficult due to their small particle size and the ability of the virus to survive in extreme conditions. Viral infections result from airborne virus particulates and can occur through entry into the human body via the respiratory tract. One means to protect the respiratory tract against infection has been through use of personal protection such as clothing and facemasks designed with textile-type materials having antiviral and virucidal properties.

In some instances, textiles have been chemically treated to have antiviral or virucidal properties. Quite often the chemical treatments can require potentially toxic chemicals or chemicals that may be otherwise harmful to the human body. Treatments can include, for example, chlorinated compounds such as polychlorinated phenols. Their contact with skin or inhalation may cause adverse reactions. This severely limits the use of such textiles in many applications particularly in the medical and personal protection fields.

Particulate filtration devices have also been employed to protect against virus transmission, such as with individual personal protection via a facemask. Because the individual virus particulates are extremely small, 20 to 250 nm, facemasks recommended for use as virus protection have relied upon a very fine particulate filter medium. These have been classified, for example, as European Standard EN 149 class FFP3 (or “filtering face pieces”). FFP3 includes respirators that are entirely or substantially constructed of filtering material capable of filtering at least 99% of airborne particulates (i.e. 99% particle filtration efficiency at 0.3 microns). To meet the efficiency, they typically require two layers of filtering material. However due to the high level of filtration of FFP3 facemasks, a high pressure drop across the facemask is incurred. This can cause the wearer some level of discomfort if the facemask is to be worn over a prolonged period of time. Further the FFP3 particulate medium generally comprises two layers: a membrane layer, and a particulate filter layer. Quite often the medium has an electrostatic charge applied to it to enhance its particulate capture ability. However, this particulate charge will subside over time (such as during storage and/or use) until, eventually, no charge exists. Such facemasks therefore provide a finite useful life.

FFP3 facemasks can be effective at capturing viruses. However, because they lack virucidal properties, the captured virus remains alive, and therefore capable of infecting.

Thus there is a need for an improved textile material that can capture, retain and destruct viruses thereby protecting against transmission of viruses. The material should have antiviral and virucidal properties, preferably without requiring chemical microbial treatments. There is also a need for antiviral textiles that are lightweight and breathable, such as for use in respiratory devices. There is a further need that such textiles be safe to use in contact with human skin and other human tissues, for personal protection. They should also not deteriorate overtime. There is a further need that such antiviral textile-containing component be used as or integrated with protective garments such as facemasks and clothing.

### SUMMARY OF THE INVENTION

In general the present invention relates to an antiviral, metal-impregnated, activated carbon cloth-containing component for use in protective products such facemasks, clothing, and related products. Such components have application in the personal protection, medical and military fields.

The component is one embodiment generally comprises at least one layer of metal-impregnated activated carbon cloth, an outer layer located along one side of the cloth, and an inner layer located along other side of the cloth. Optionally there can be a membrane layer positioned between the outer layer and activated carbon cloth.

Although activated carbon cloth is naturally antibacterial, it is not generally considered to be useful alone for capture of virus particulates because viruses have a very small particulate size. Their small size can enable the viruses to pass through the cloth or, if they do not, it is generally thought that the viruses could likely fall off or remain alive on the cloth. However, the inventors have surprisingly discovered that activated carbon cloth, when impregnated with metal (such as an antimicrobial metal such as silver or copper produced using the processes described herein to specific standards) results in a cloth having antiviral and virucidal properties. Further, the combination of outer and inner layers with the metal impregnated cloth described herein serves to draw viruses from a static and mobile environment into the cloth assembly where they can be captured. Once captured, the virus particulates are held and killed within the structure of the cloth assembly. The inventors have discovered that when coupled with the generic physical and chemical properties of activated carbon cloth, these additional properties offer a wider range of applications than conventional products, including personal filtration masks already in the market place.

In an example, the cloth component is used in a facemask assembly for virus protection. The inventors have found that such facemask assembly provides antiviral effectiveness. Additionally, the facemask assembly has a relatively low burden on the user and offers superior comfort with a much reduced pressure differential to conventional recommended filtration media for antiviral facemask applications.

Other applications where the antiviral and virucidal properties of activated carbon cloth combined with metal, and specifically with silver, are of benefit are also described, including medical clothing such as gowns and scrubs, bed linens, clothing, and protective gear and clothing for military purposes.

Those and other details, objects, and advantages of the present invention will become better understood or apparent from the following description and drawings showing embodiments thereof.

### BRIEF DESCRIPTION OF THE DRAWINGS

The accompanying drawings illustrate examples of embodiments of the present invention:

FIG. 1 shows a general schematic of a metal-impregnated activated carbon cloth component according to an embodiment of the present invention.

FIG. 2 shows an embodiment of a metal-impregnated activated carbon cloth component for use in a facemask composite according to an embodiment of the present invention.

FIG. 3 shows another embodiment of a metal-impregnated activated carbon cloth component for use in a facemask composite according to an embodiment of the present invention.

FIG. 4 shows another embodiment of a metal-impregnated activated carbon cloth component for use in a facemask composite according to an embodiment of the present invention.

FIG. 5 shows an embodiment of a metal-impregnated activated carbon cloth component for use in clothing according to an embodiment of the present invention.

FIG. 6 shows an embodiment wherein the component includes a three layer laminate according to an embodiment of the present invention.

FIG. 7 shows an embodiment wherein the component includes a three layer laminate and an outer lining according to an embodiment of the present invention.

FIG. 8 shows an embodiment of the present invention wherein the component has a three layer laminate and an outer and inner lining according to an embodiment of the present invention.

### DETAILED DESCRIPTION

In all of its various embodiments and related aspects, provided herein are metal impregnated activated carbon cloth components having antiviral and virucidal properties. Several embodiments are directed to components containing activated carbon cloth impregnated with silver, although equally adaptable to other antimicrobial metals such as copper, as well as to antimicrobially active metal derivatives such as oxides and ions. Such antimicrobial metals and metal derivatives are considered not to be chemical antimicrobials as used herein. Further, “nanoparticles” as used herein means any particle having an average particle diameter of less than about 1000 nm. Preferably, the nanoparticles useful with the components herein is less than about 500 nm, and more preferably is less than about 100 nm.

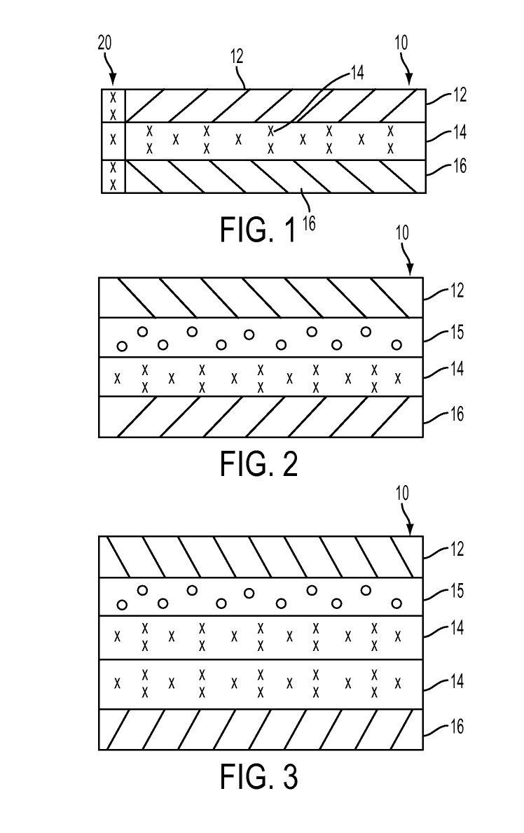

As shown for example in FIG. 1, in an embodiment, the component 10 comprises of three layers: an outer layer 12, an impregnated activation carbon cloth layer 14 and an inner layer 16. The outer 12 and inner 16 layers are made of a woven or non-woven material. The impregnated activated carbon cloth 14 is made of a knitted or woven material. The carbon cloth 14 has a weight of about 100 to 300 g/sqm. Its adsorption capacity for ethyl acetate is 20% to 80% by weight.

The layers of component 10 can be held together by an attachment means 20 that are positioned along all or a portion of the perimeter. Attachment means may also be placed elsewhere, provided they do not undesirably interfere with filtration or other features of the component as a filtration, capture, and virucidal component. Attachment means 20 can include, for example, stitching, fastening, adhesive, ultrasonic welding, needle punching, melt welding. In some embodiments, described further below, adhesive 25 is used with lamination.

In an embodiment, as shown for example in FIG. 2, there is a fourth layer, a membrane 15 positioned between the outer layer 12 and carbon layer 14. Optionally a second layer of activated carbon cloth 14 can be used adjacent to the first layer of carbon cloth as shown for example in FIG. 3.

The metal-impregnated activated carbon cloth can be produced through a carbonization and activation process. The process can be one step, two steps, and can be of a continuous batch nature. The carbonization is carried out in an oxygen free atmosphere at temperatures of about 350° C. The activation can be carried out in a steam or CO₂ atmosphere at about 900° C. The starting material can be a viscose rayon or polyacrylonitrile in the form of woven or knitted materials or nonwoven materials such as felts. Prior to carbonization and activation, the raw material is impregnated with a solution of inorganic halides. This can include halides of the metals such as zinc, aluminum, calcium, magnesium, iron (which all have halides with the common, apparently essential Lewis acid characteristics), lead, cobalt and barium. Additionally or alternatively, antimicrobial metals (“metals” as used herein shall include zero-valent metals, as well as metal precursors and derivatives, such as metal oxides and/or metal ions) such as copper and silver can be incorporated in the impregnation to enhance the antimicrobial properties of the final product. During the carbonization and activation processes, metal salt is converted into metal oxide and then into metal. For example, a silver salt is converted into silver oxide and finally into silver metal. Optimally, the metal is substantially generally uniformly dispersed throughout the cloth, or pre-selected regions of the cloth. “Impregnated” as used herein means the metal(s) securely reside in the cloth in any fashion, for example whether as a coating on fibers, located in interstitial spaces between fibers, embedded into fibers, or otherwise substantially attached and retained by the cloth throughout the intended uses described herein. The process of manufacture can be that described in U.S. Pat. No. 4,529,623, for example, which patent is incorporated herein by reference. The resulting activated carbon cloth has a microporous structure capable of attracting and capturing molecules.

During impregnation, metal salts, such as silver chloride, are uniformly distributed into the cloth. During the impregnation manufacturing process, a metal salt is converted to nano particulate metal. In an example, the metal particles are deposited to extend through the thickness of the cloth. The metal is incorporated in an amount sufficient to enhance antiviral properties. In an example, the amount comprises 0.05 to 1% by weight of metal. In a preferred example, the metal is silver. The cloth thickness is in the range of from about 0.2 mm to about 2 mm, the cloth is woven or knitted and has a weight in the range of about 100 to 300 g/sqm. It has an adsorption capacity for ethyl acetate in the range of about 20% to 80% by weight. In an example the cloth is activated carbon cloth, FM10 (produced by Chemviron Carbon Cloth Division), impregnated with silver 0.3% by weight of metal. The thickness is 0.5 mm, the weight is 120 g/sqm, and the adsorption capacity for ethyl acetate is 35% by weight. In another example, the cloth is activated carbon cloth, FM30K (produced by Chemviron Carbon Cloth Division), impregnated with silver 0.3% by weight of metal. The thickness is 0.4 mm, the weight is 110 g/sqm and the adsorption capacity for ethyl acetate is 35% by weight.

### Antiviral Testing

Activated carbon cloth both with and without a metal impregnation was tested for efficiency against virus capture, retention and destruction using an MS-2 coliphage. For this testing silver metal was used. After showing the effects on virus capture, retention and destruction, the activated carbon cloth was tested as a component of a filtration composite for a facemask. The activated carbon cloth filtration composite was compared against two variants of a FFP3 facemask for effectiveness against virus capture, retention, destruction and also pressure drop. The advantages of using activated carbon cloth with silver as a component of an antiviral facemask composite were also considered. The activated carbon cloth was also tested as a component of a filtration composite for clothing or incorporation into clothing.

### Virus Capture

Samples of woven activated carbon cloth (FM10 cloth produced by Chemviron Carbon Cloth Division) were obtained for testing. Six examples of activated carbon cloth were assembled. One half of the cloth examples contained silver and the other half did not. Each of the examples had 1, 3 or 4 layers of cloth. The layers were placed directly on top of each other.

Using the Henderson Apparatus a challenge of over 10⁹ MS-2 coliphage aerosols was delivered to the filter sample at a relative humidity of 95% or above at 30 litres per minute for one minute. The airflow rate was representative of the speed the virus aerosol would travel if ejected from the human body via a sneeze. The apparatus consisted of impingers both up and downstream of the filter sample. After challenging the filter sample to the collision spray, the spores collected in the impingers were assayed and the percentage removal of virus from the air stream due to the filter was calculated. Table 1 below shows the results of the virus capture capabilities of one layer to multiple layers of the activated carbon cloth with and without silver.

TABLE 1

| Sample # | Cloth Type | No' of layers | Impregnation | % Capture |
|---|---|---|---|---|
| 1 | FM10 | 1 | None | 9 |
| 2 | FM10 | 3 | None | 57 |
| 3 | FM10 | 4 | None | 91 |
| 4 | FMl0Ag | 1 | Silver (0.3%) | 22 |
| 5 | FMl0Ag | 3 | Silver (0.3%) | 50/65 |
| 6 | FMl0Ag | 4 | Silver (0.3%) | 88 |

The virus capture capabilities represent the amount of virus that is trapped in the cloth from an initial challenge. When considering only the presence of silver on the carbon cloth, the results indicate the silver has no adverse effect on the capture of virus in activated carbon cloth.

### Virus Retention

After testing sample 6 for virus capture, the sample was removed, reversed and placed back into the sample holder. Clean air was passed through the sample at 30 L/min for 1 minute. The spores collected in the impingers were assayed and the percentage virus retained within the sample was calculated. Table 2 shows the results of virus retention of the sample 6 activated carbon cloth with silver.

TABLE 2

| Cloth Type | Impregnation | No' of layers | Retained Virus (%) |
|---|---|---|---|
| FM10 | Silver | 4 | 99.9998 |

The retention capabilities represent the amount of virus that remains, in the cloth after capture. Results indicate that 99.9998% of the virus is retained within activated carbon with silver once it has been captured.

### Virucidal

Using established microbial generation and retrieval methods, one inch squares of each material, FM10, FM10 Ag, antimicrobial treated polypropylene, and two particulate filtration components that together provide FFP3 filtration efficiency, were tested against MS-2 coliphage. The test materials were sterilised, contaminated with 100 μl of the MS-2 coliphage and tested by culture assay for microbial activity at time 0 and after 6 hour incubation at 37° C. and relative humidity >40%.

A number of materials were tested. The materials included activated carbon cloth with and without silver, a polypropylene with an anti microbial coating, and the two material components of an FFP3 filtration media. Table 3 shows the results of the virucidal properties of several filtration media.

TABLE 3

| Material | Treatment/Impregnation | Virus killed (%) |
|---|---|---|
| FFP3 particulate filter | None | 0 |
| medium | | |
| FFP3 particulate filter | None | 0 |
| membrane | | |
| Polypropylene fabric | Antimicrobial | 0 |
| FM10 | None | 93 |
| FM10 | Silver | 98 |

Results show the only materials with any virucidal properties were activated carbon cloth, both with and without silver. Surprisingly, activated carbon cloth alone exhibited virucidal properties. However, the virucidal properties of the cloth were significantly increased with the impregnation of nano particulate silver metal.

### EXAMPLES

### Facemasks

In examples, a component was assembled as filtration media in a facemask composite. The component 10 comprised of an outer layer 12 and an inner layer 16, a protective membrane 15 and silver impregnated activated carbon cloth 14. In examples, the sequence of the assembled component materials was as follows: outer layer 12, protective membrane 15, activated carbon cloth 14 impregnated with silver, and an inner layer 16 for location closest to the wearer. The individual layers were laid on top of each other but were not fixed to one another. The component of layers could be fitted in the mouth piece of a facemask or used to make the whole facemask.

The outer, inner and protective membrane layers are selected to optimize the virus capture capabilities of the activated carbon cloth. A heavier outer or membrane layer increases the virus capture rate of the cloth. It is thought this is due to the additional weight of material slowing down the virus particulates, making them more susceptible to capture within the activated carbon cloth. In addition, membrane layers were selected for protection of the activated carbon cloth and for comfort to the wearer. Generally the outer layer 12 is selected to be of a heavier weight than the inner layer 16. In examples the outer layer 12 comprises a material having a weight in the range of 10-100 g/sqm and has an air permeability in the range of 200-5 cm³/cm²/sec. The inner layer 16 comprises a material having a weight in the range of 10-100 g/sqm and has an air permeability in the range of 200-5 cm³/cm²/sec. In an example, the outer layer 12 weighs 40-60 g/sqm and the inner layer 16 is 20-40 g/sqm.

The protective membrane 15 is selected to improve adsorption efficiency of the activated carbon cloth 14, which can become compromised during aerosol challenge. The weight of the membrane was varied and tested. In each case each sample contained one layer of ACC and the weights of the inner and outer layers were the same in all cases. The outer layer 12 weighed 40-60 g/sqm and the inner layer 16 was 20-40 g/sqm. The results are shown in Table 4 below.

TABLE 4

| Membrane (g/sqm) | Virus Capture (%) |
|---|---|
| 22 | 98.26 |
| 40 | 99.28 |
| 60 | 99.88 |

The results demonstrated that increasing the weight of the membrane increased the efficiency of virus capture. Similarly, it is thought this may be due to the additional mass further slowing up the virus particulates, thus making them more susceptible to capture within the ACC. However, the weight is not increased too much to ensure that permeability is not overly limited. In an example the membrane 15 comprised a material having a weight in the range of 20-100 g/sqm and an air permeability in the range of 500-100 L/m²/S at 200 Pa. Optionally, the protective membrane has a NaCl penetration of 0.1-2%.

In a first facemask example, a facemask composite was assembled to have the following configuration: an outer layer of polypropylene non-woven cloth 12, a protective polypropylene membrane layer 15, a layer of silver impregnated activated carbon cloth 14 and an inner layer of viscose non-woven cloth 16. The outer layer had a weight of 50 g/sqm and the inner layer weighed 30 g/sqm. The activated carbon cloth was FM10, having a silver impregnation resulting in 0.3% by weight silver. The membrane had a weight of 60 g/sqm. This composite represented a facemask that is intended to have a lower pressure differential and reasonable cost. The layers were not fixed together but were laid on top of one another. The composite is designed such that the mask piece shape can be cut and joined around the edges or can be sealed into a mask framework. The facemask composite is shown for example in FIG. 2.

In a second example, the configuration resembled that of the first example except that two layers of silver impregnated activated carbon 14 were used. The configuration included an outer layer of polypropylene non-woven cloth 12, a protective polypropylene membrane layer 15, a layer of silver-impregnated activated carbon cloth 14, a second layer of silver impregnated activated carbon 14, and an inner layer of viscose non-woven cloth 16 as shown for example in FIG. 3.

In both examples the activated carbon cloth was impregnated with 0.3% by weight of silver. The cloth thickness was about 0.5 mm The cloth weight was about 120 g/sqm and the adsorption capacity for ethyl acetate was about 35% by weight. The layers were not fixed but were laid on top of one another. The composite is designed such that the mask piece shape can be cut and joined around the edges or can be sealed into a mask framework.

To determine the antiviral efficacy of the component 10 as used in a facemask composite, several components were assembled according to parameters in the above mentioned first and second examples. Assemblies were tested by determining the activated carbon cloth viral capture and air permeability performance of each activated carbon cloth filtration assembly. Then the results were compared to that of a traditional FFP3 facemask exemplary of that typically recommended for virus protection. The FFP3 facemask contained particulate filter layers of 150-250 g/sqm and 50-150 g/sqm, and had an outer layer of 20-100 g/sqm and an inner of 20-100 g/sqm. The facemask consisted of one set of two layers, however some can contain two sets of two layers (combined total of four layers to provide FFP3 efficiency). Table 5 shows the results of two recommended FFP3 facemasks along side the above two described facemasks containing activated carbon cloth with silver as a component in a facemask composite.

TABLE 5

| | No' of layers | | Virus | Air permeability |
|---|---|---|---|---|
| Mask | of activated | Impregnation/ | Capture | @ 10 mmH20 |
| Composite | carbon cloth | Treatment | (%) | (cm³/cm²/sec) |
| FFP3 Mask | 0 | None | 97.86 | N/D |
| Composite 1 | | | | |
| FFP3 Mask | 0 | None | 97.25 | 8.38 |
| Composite 2 | | | | |
| ACC Mask | 1 | Silver | 99.88 | 10.29 |
| Composite | | | | |
| ACC Mask | 2 | Silver | 99.92 | 9.01 |
| Composite | | | | |

These results show that one layer of activated carbon cloth in a filtration composite can provide better protection than a FFP3 facemask filtration composite recommended for virus protection. The air permeability across this filtration media is improved by 23% compared with the FFP3 facemask filtration composite. Thus, activated carbon cloth impregnated with silver could be used in facemask applications for reducing the risk of virus transmission. It is proven that activated carbon cloth impregnated with silver can provide additional benefits such as virus retention and destruction, as well as enhanced protection against virus capture when compared with recommended FFP3 antiviral facemasks.

In a third facemask example, the component 10 comprised of a metal-impregnated activated carbon cloth 14 positioned between an outer layer 12 and an inner layer 16, and had a FFP3 filtration media 17 positioned between the inner layer 16 and the carbon cloth 14. The configuration included an outer layer 12 of polypropylene non-woven cloth (50 g/sqm), a layer of silver-impregnated activated carbon cloth 14, a layer of each FFP3 filtration component 17a and 17b, and an inner layer 16 of viscose non-woven cloth (20 g/sqm). The activated carbon cloth 14 included FM10, impregnated with 0.3% by weight of silver.

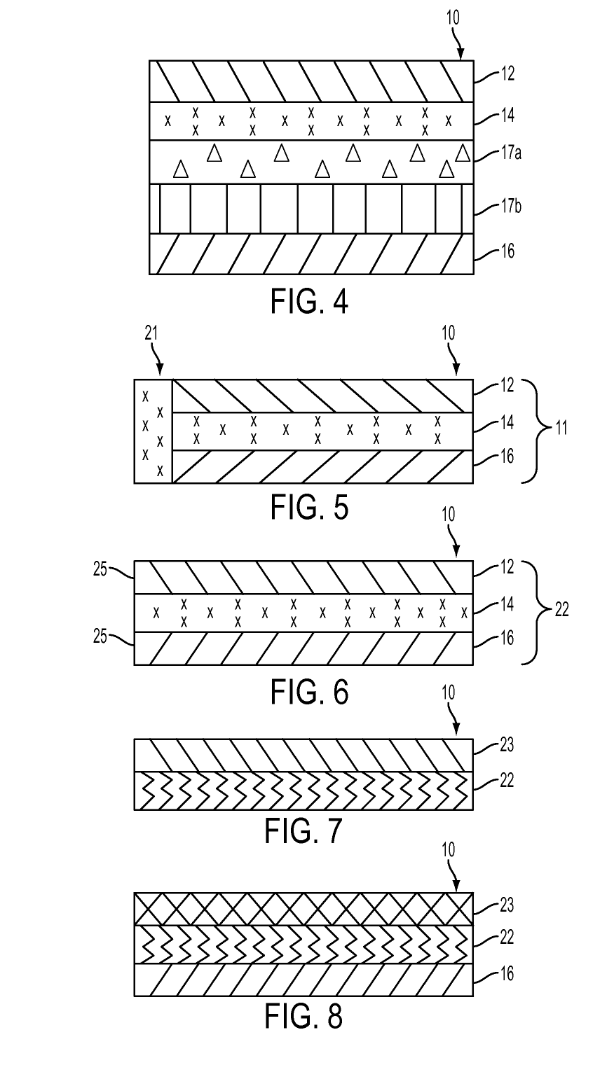

In an example as shown in FIG. 4, the FFP3 layer comprised of two layers 17a and 17b. The first layer 17a was a polypropylene and the second layer 17b was a polypropylene/polyester/polyacrylonitrile material. Each FFP3 layer has a certain filtration capability. It is only when these materials are combined that the capability reaches that of FFP3. Most if not all FFP3 filtration components currently used in facemask applications are made up of two layers. In the example, the layers were not fixed, rather were laid on top of one another. However in facemask applications the edges of the composite could be attached by stitching, needle punching, ultrasonic weld or sealing within the facemask framework. The third facemask using FFP3 filtration media was tested to determine its virus capture capabilities. The following Table 6 shows the virus capture results for the facemask composite from FIG. 4, where an FFP3 filter medium was also included. The outer layer was polypropylene 50 g/sqm, the inner layer was viscose 30 g/sqm. The ACC was a woven grade.

TABLE 6

| Sample | Virus Capture (%) |
|---|---|
| Polypropylene outer | 99.99 |
| (50 g/sqm)/ACC/FFP3/viscose | |
| (30 g/sqm) | |

### Clothing and Bedding Applications

In embodiments the metal-impregnated activated carbon cloth component is used in medical clothing such as gowns and scrubs, and in bedding materials. In an example such as shown in FIG. 5 the component comprises a silver-impregnated activated carbon cloth 14 positioned between an outer layer 12 and an inner layer 16. The three layers are unlaminated 11 and held together using stitching 21 or other means of fixation at a part or all of the perimeter. Optionally, a membrane layer 15 may be used. It would have a weight in the range of 20-100 g/sqm and an air permeability in the range of 500-100 L/m²/S at 200 Pa. Preferably the weight would be 60 g/sqm.

Alternatively, as shown in FIG. 6, the three layers can be laminated together. For an example, the laminate 22 is formed using an adhesive 25 in combination with heat and pressure. Adhesive 25 is applied between layers 12 and 14, and layers 14 and 16 in an amount sufficient to hold the layers 12, 14, 16 together. The adhesive comprises one of ethyl vinyl acetate, polyester or polyamide. The adhesive is applied at 10 to 100 g/sqm. The layers are lamented at 50° C. to 250° C. using a pressure range of 0.5 to 5.0 bar. Alternatively, the three layer system can be used alone to form the garment. Further layers of metal impregnated activated carbon cloth 14 can be added to increase the level of protection.

Optionally the three layer configuration 11 or 22 is used in combination with other materials, 23 and 16. The outer material 23 would be of a heavier weight than material 16. Generally the outer material 23 is selected to either be a waterproof outer material, such as for coats or trousers, and would be a heavy duty fabric, or even a heavier fabric such as those used for upholstery for curtains, seating, and the like. Material 23 is selected to provide additional characteristics of strength, durability and/or fire retardancy. In an example, outer material 23 has a specification of 100 to 1000 g/sqm to form a garment of medical clothing or bedding materials as desired. Examples are shown in FIGS. 7 and 8. Component 10 in FIGS. 7 and 8 can be particularly useful for making whole garments of clothing, particularly outdoor clothing or upholstery such as seating or curtains.

Three samples were constructed according to the composition of FIG. 5. The outer and inner layers fit into the same specifications set for the facemask composite outer and inner layers. The samples were tested for virus capture capabilities. The results are shown in Table 7.

TABLE 7

| | Layers of | Activated | Virus |
|---|---|---|---|
| | Activated | Carbon | Capture |
| Clothing Composite | Carbon Cloth | Cloth Type | (%) |
| Polypropylene outer | 2FM10 | Woven | 84.62 |
| (50 g/sqm)/ACC/viscose inner | | | |
| (30 g/sqm) | | | |
| Polypropylene/polyester outer | 2FM10 | Woven | 75.75 |
| (50 g/sqm)/ACC/viscose inner | | | |
| (30 g/sqm) | | | |
| Nylon outer/ACC/polyester | 1 FM30K | Knitted | 46.67 |

Single and double layers of activated carbon cloth were also tested. This demonstrated that increasing the layers of activated carbon cloth in clothing would increase the level of virus protection. The results are shown in Table 8.

TABLE 8

| | Layers of | Activated | Virus |
|---|---|---|---|
| | Activated | Carbon | Capture |
| Clothing Composite | Carbon Cloth | Cloth Type | (%) |
| Polypropylene outer | 1 | Woven | 60.36 |
| (50 g/sqm)/ACC/viscose inner | | | |
| (30 g/sqm) | | | |
| Polypropylene outer | 2 | Woven | 84.62 |
| (50 g/sqm)/ACC/viscose inner | | | |
| (30 g/sqm) | | | |

The following Table 9 shows the effect of varying the weight of the polypropylene outer layer 12. All samples contained one layer of woven ACC. The inner layer was the same in all cases.

TABLE 9

| Outer (g/sqm) | Virus Capture (%) |
|---|---|
| 20 | 28.42 |
| 40 | 56.14 |
| 50 | 84.62 |

Results prove that increasing the weight of the outer layer increases the efficiency of virus capture. It is thought this is due to the additional mass further slowing up the virus particulates, making them more susceptible to capture within the ACC.

In various examples the component contains activated carbon cloth impregnated with silver. The component can be used as a lining or alone for clothing for both patient and healthcare workers to include uniforms, scrubs, surgical gowns and drapes, gloves etc. In examples the three layer component is used alone to form the garment, such as undergarments, medical clothing, bed linens, draperies as component 10 in FIG. 6, or used as a component 10 within a garment, such as a lining of a garment or linen in FIG. 5, 6 or 7.

It can also be used within medical bedding to include mattresses, bed covers and pillows, curtains and seating in order to capture, retain and kill viruses in a hospital setting. Here the activated carbon cloth component with silver can be incorporated as a layer within the construction of the final product. Assemblies can vary somewhat from the filtration-driven facemask assembly mentioned above, since air permeability would not be as critical. For example, the membrane would not be required as complete protection, and therefore would not be as critical in these applications. However, where increased protection is desired, a membrane 15 could be included in any one of components 10 shown in FIGS. 5-8. Membrane 15 would have a weight in the range of 20-100 g/sqm and an air permeability in the range of 500-100 L/m/S at 200 Pa.

These examples can also require different properties from the laminates, for example, stretch, water repellency, etc. FIGS. 5 and 6 configurations would typically be used for lightweight garments of clothing such as underwear and items that require stretch and comfort. Those configurations can also be used to make bed linen and medical garments such as surgical or medical drapes or coverings. FIGS. 7 and 8 illustrate the use of the component laminate as a lining within a garment of clothing. The component 10 shown in FIGS. 7 and 8 could be used to make garments that would require a heavy duty outer such as outdoor clothing and soft furnishings such as curtains and seating.

In still other examples, the metal-impregnated component is incorporated into a lining within protective clothing used in military to combat chemical warfare agents and viruses. Activated carbon cloth alone can provide protection against chemical warfare agents via adsorption. However, the addition of an antimicrobial metal would increase the level of protection to include anti viral and virucidal properties.

The present invention has been described with reference to specific details of particular embodiments thereof. It is not intended that such details be regarded as limitations upon the scope of the invention except insofar as and to the extent that they are included in the accompanying claims.

What is claimed is:

1. An antiviral component comprising of:
an activated carbon cloth, wherein the activated carbon cloth comprises at least one antimicrobial metal substantially uniformly distributed therein;
an inner layer positioned along one side of the activated carbon cloth; and
an outer layer positioned along an opposite side of the activated carbon cloth, wherein the layers and activated carbon cloth are attached at all or a portion of a perimeter thereof.

2. The component of claim 1 further comprising a protective membrane positioned between the outer layer and the activated carbon cloth.

3. The component of claim 1 wherein the antimicrobial metal is at least one of copper and silver.

4. The component of claim 1 wherein activated carbon cloth comprises about 0.05 to about 1% by weight of antimicrobial metal.

5. The component of claim 1 wherein the activated carbon cloth has a thickness in the range of from about 0.2 mm to about 2 mm.

6. The component of claim 1 wherein the activated carbon cloth has a weight in the range of from about 100 to 300 g/sqm.

7. The component of claim 1 wherein the activated carbon cloth has an adsorption capacity for ethyl acetate in the range of from about 20 to 80% by weight.

8. The component of claim 1 wherein the outer layer is a polypropylene non-woven material.

9. The component of claim 1 wherein the inner layer is a viscose non-woven material.

10. The component of claim 1 wherein the outer layer comprises a material having a weight in the range of 10-100 g/sqm and has an air permeability in the range of 200-5 cm/cm/sec.

11. The component of claim 1 wherein the inner layer comprises a material having a weight in the range of 10-100 g/sqm and has an air permeability in the range of 200-5 cm/cm/sec.

12. The component of claim 1 wherein the outer layer weighs about 40-60 g/sqm and the inner layer weighs about 20-40 g/sqm.

13. The component of claim 2 wherein the protective membrane comprises a material having a weight in the range of 20-100 g/sqm and an air permeability in the range of 500-100 L/m²/S at 200 Pa.

14. The component of claim 2 wherein the protective membrane has a NaCl penetration of 0.1-2%.

15. The component of claim 2 wherein the protective membrane is a polypropylene.

16. A facemask having antiviral properties comprising of:
a facemask having a breathing piece, the breathing piece being lined with an outer layer of non-woven material;
a membrane positioned along one side of the outer layer;
a first layer of activated carbon cloth, wherein said activated carbon cloth is impregnated with at least one antimicrobial metal, the metal substantially uniformly dispersed throughout the carbon cloth, and wherein the cloth is positioned along an opposite side of the membrane, wherein the silver is; and
an inner layer of non-woven cloth positioned along the other side of the carbon cloth.

17. The facemask of claim 16 wherein the outer layer is a polypropylene non-woven material.

18. The facemask of claim 16 wherein the inner layer is a viscose non-woven material.

19. The facemask of claim 16 wherein the membrane is a polypropylene.

20. The facemask of claim 16 further including a second layer of metal-impregnated activated carbon aligned with the first layer of carbon cloth.
